(19) United States
(12) Patent Application Publication
(10) Pub. No.: US 2014/0210405 A1
(43) Pub. Date: Jul. 31, 2014

(54) PORTABLE WIRELESS CHARGER

(71) Applicant: SAMYA TECHNOLOGY CO., LTD., Taoyuan County (TW)

(72) Inventor: Fu-I YANG, Taoyuan County (TW)

(73) Assignee: SAMYA TECHNOLOGY CO., LTD., Taoyuan County (TW)

(21) Appl. No.: 13/753,886

(22) Filed: Jan. 30, 2013

(51) Int. Cl. H02J 7/00

(52) U.S. Cl. CPC H02J 7/0044
USPC 320/108

(57) ABSTRACT

The invention relates to a portable wireless charger, particularly to the secondary batteries of the nickel-hydrogen batteries and nickel-cadmium batteries having the parallel-connected separated detection charging mode and series-connected combined discharging mode to achieve highest efficiency of power release. The present invention also provide a DC TO AC output control unit coupled with the power storing unit and converting a discharging current into an output power with a predetermined voltage level and a wireless power transmitter having stable high efficiency of the output power. Whereby the present invention provides the slim portable wireless charging platform for charging mobile devices with built-in wireless inductive receiver without electrical contacts to enhance ease of use and safety effect.

### BACKGROUND OF THE INVENTION

1. Field of the Invention

The invention relates to a portable wireless charger, particularly to the AA or AAA secondary batteries such as nickel-hydrogen batteries and nickel-cadmium batteries having parallel-connected separated charging mode and series-connected combined discharging mode to charge the mobile devices without electrical contacts.

2. Description of the Related Art

Increasing power consumption of mobile devices such as iPhone, iPod type of phone or tablet cannot replace the battery. When the battery depletion occurs outdoors, the mobile device is not able to be used. Therefore, a portable power emerges.

The above-mentioned mobile device is charged by a connector so there must be a connection opening arranged on the mobile device; thus, it is easy for moisture penetrating into the internal circuit of the mobile device by the connection opening to affect the service life of the electronic components. Besides, different specifications of the connector must be prepared for different power specifications of the mobile devices, which is inconvenient.

Currently, the mobile device can be charged by a wireless charging device without the connector. Wherein the Wireless Power Consortium, WPC established on Dec. 17, 2008 has researched and developed a fast and convenient wireless charging technology for low-power electronic devices with less 5 W, including mobile phones, PMP, digital cameras, electronic games, and other mobile devices. The principle of the wireless charging device is about Faraday's law of electromagnetic induction. A coil is energized to generate a magnetic force and another coil generates a magnetic force after induction. The use of this principle is to produce electricity through the changes in the magnetic field to achieve the purpose of wireless charging. The aforesaid feature is disclosed in U.S. Pat. Nos. 5,959,433, 7,948,209 and 8,248,026.

The conventional wireless charger uses a transformer as a transmitting power having advantage of providing stable output power but the conventional wireless charger is not able to provide charging without a power outlet. Another disadvantage of the conventional wireless charger is to be charged in a fixed position; that is, when taking away the charging mobile devices, the mobile devices stop being charged.

Some people use the conventional wireless charger to charge the battery and then use a wired connector to charge the mobile device to achieve the portable function but the drawbacks are that the phone must wear a thick and heavy battery clip and the wireless clip still needs to be charged by AC power, which is very inconvenient.

Most of the portable mobile power use built-in lithium batteries as a power storage unit. Although the lithium battery has characteristics of high energy density, low temperature and stability of storage capacity, it has power consumption problem and electrolysis unit which may explode in an overcurrent condition which has safety concerns. Due to different specifications of the lithium batteries of various brands, the internal lithium batteries of the charger cannot be used in general electronic products.

Comparing to the lithium batteries, the nickel-hydrogen batteries, nickel-cadmium batteries or alkaline batteries, the most extensive use of AA or AAA batteries, are world unified specification so that they can be used in various electronic products.

To conventional AA or AAA batteries as the power storage unit has to overcome the problems of charging and discharging. This kind of battery has voltage of 1.2V˜1.5V so that at least four batteries in series are fully charged to provide voltage of 4.8V˜6V. To this end, four batteries in series are set in the charger and are charged by the charging current. After being fully charged, four batteries are in series for discharging. However, charging in series forms an uneven charging of each battery and affects the charging quality and service life of the batteries. For example, the first battery may be overcharged but the last battery may not be fully charged.

Therefore, the present invention provides a portable wireless charger having the nickel-hydrogen batteries, nickel-cadmium batteries or alkaline batteries as a power storing unit to solve the problems of the lithium batteries and combines with the wireless charging technology to conduct the effective charging and discharging.

### SUMMARY OF THE INVENTION

It is a primary object of the present invention to provide a portable wireless charger having a slim portable wireless charging platform for charging mobile devices with built-in wireless inductive receiver without any connector and sensor clip at any time to avoid the reliability problems derived from exposed connector.

It is the second object of the present invention to provide the AA or AAA secondary batteries of nickel-hydrogen batteries and nickel-cadmium batteries as the power storing unit to solve the explosion problem caused by the power consumption and the lack of current of the conventional wireless charger with lithium batteries and further provide the parallel-connected separated charging mode and series-connected combined discharging mode to achieve the highest efficiency of power release.

It is the third object of the present invention to solve the problems of low charging efficiency and sensor fever caused by the unstable output power of the conventional wireless charger and to provide the intelligent power stability and control system for a wireless sensor with stable and efficient output power.

In order to achieve the above objects, the portable wireless charger, comprising: a body having a first surface, a second surface and a DC input port; a charging unit arranged in the body, having a microprocessor and related electronic components for outputting a charging current and an end thereof electronically connected to the DC input port; an power storing unit provided for storing the charging current as electrical energy; a wireless power transmitter coupled with the power storing unit and having a controller, a driver, a first coil and a sensor for converting the electrical energy into a AC signal and transmitting the AC signal to a receptor of an electronic device by the first coil.

Wherein the power storing unit arranged in the body is composed of a multiple of nickel-metal hydride batteries in series; each of the nickel-metal hydride batteries has an anti-adverse-current element at a positive terminal thereof and a terminal voltage detection point arranged between the anti-adverse-current element and the positive terminal of the nickel-metal hydride battery is couple with the microprocessor; each of the nickel-metal hydride batteries has a switch at a negative terminal thereof for each of the nickel-metal hydride batteries forming a separate charging circuit; when the power storing unit is at a LOW voltage level, the switches are turned off for the adjacent batteries being non-conductive so that the charging unit outputs the charging circuit to each of the nickel-metal hydride batteries to form a plurality of charging loop and a parallel-connected separated detection charging mode; when each of the nickel-metal hydride batteries is fully charged and the microprocessor detects a high voltage level, the switches are turned on and the parallel separate charge of the nickel-metal hydride batteries is converted to a series-connected combined discharging mode; a DC TO AC output control unit is coupled with the power storing unit and converts a discharging current into an output power with a predetermined voltage level and at least a first output power is coupled with the wireless power transmitter.

Whereby the power storing unit provides the “parallel-connected separated charging mode” and “series-connected combined discharging mode” to conduct charging and discharging and combine with the DC TO AC output control to provide stable high efficiency of the output power to the wireless power transmitter.

Based on the features disclosed, the present invention provides the control means of the parallel-connected separated charging mode and series-connected combined discharging mode to achieve the highest efficiency of power release. Moreover, the present invention provides the slim portable wireless charging platform for charging mobile devices with built-in wireless inductive receiver without electrical contacts to enhance ease of use and safety effect.

### BRIEF DESCRIPTION OF THE DRAWINGS

FIG. 1 is a perspective view of the appearance of the preferred embodiment in accordance with the present invention;

FIG. 2 is a schematic view of the circuit framework in accordance with the present invention;

FIG. 3 a schematic view of the charging mode in accordance with the present invention;

FIG. 4 is a schematic view of the discharging mode in accordance with the present invention;

FIG. 5 is a flow diagram, illustrating the control operation of the charging unit in accordance with the present invention; and

FIG. 6 is a flow diagram, illustrating the control operation of the wireless power transmission in accordance with the present invention.

### DETAILED DESCRIPTION OF THE PREFERRED EMBODIMENT

First, it is understandable for skilled person that some certain words in this description and the subsequent claims are referred to specific components. Second, the components in this description and the subsequent claims are not distinguished by different terms of the components but the different functions of the components. Third, the term “include” or “comprise” in this description and the subsequent claims is referred to an open term which should be interpreted as “including, but not limited to.” Besides, the term “coupled with” includes direct and indirect means of electrical connection. Last, the term nickel-hydrogen batteries include the rechargeable secondary battery such as nickel-cadmium batteries or alkaline batteries.

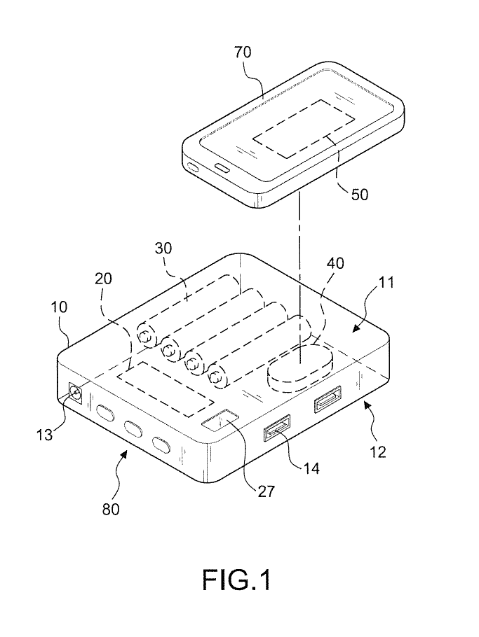

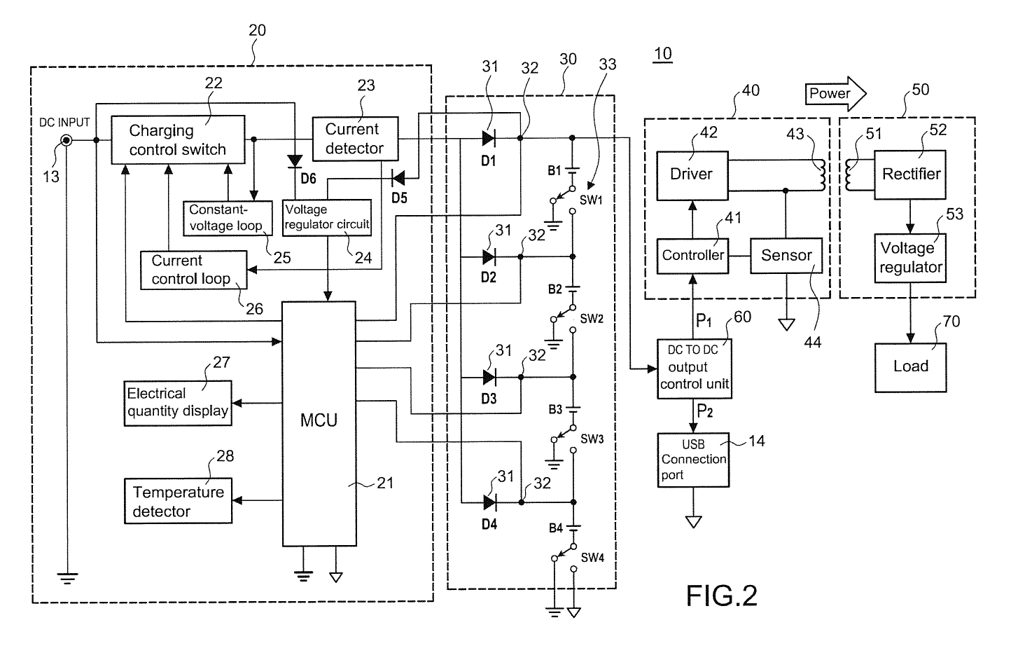

Referring to FIGS. 1 through 2, the preferred embodiment of a potable wireless charger 80 in accordance with the present invention comprises: a body 10 having a first surface 11, a second surface 12 and a DC input port 13; a charging unit 20 arranged in the body 10, having a microprocessor 21 and related electronic components for outputting a charging current Ic and an end thereof electronically connected to the DC input port 13; an power storing unit 30 provided for storing the charging current Ic as electrical energy; a wireless power transmitter 40 coupled with the power storing unit 30 and having a controller 41, a driver 42, a first coil 43 and a sensor 44 for converting the electrical energy into a AC signal and transmitting the AC signal to a receptor 50 of a mobile device 70 by the first coil 43. The wireless charging principle is a prior and thus will not be described in details here.

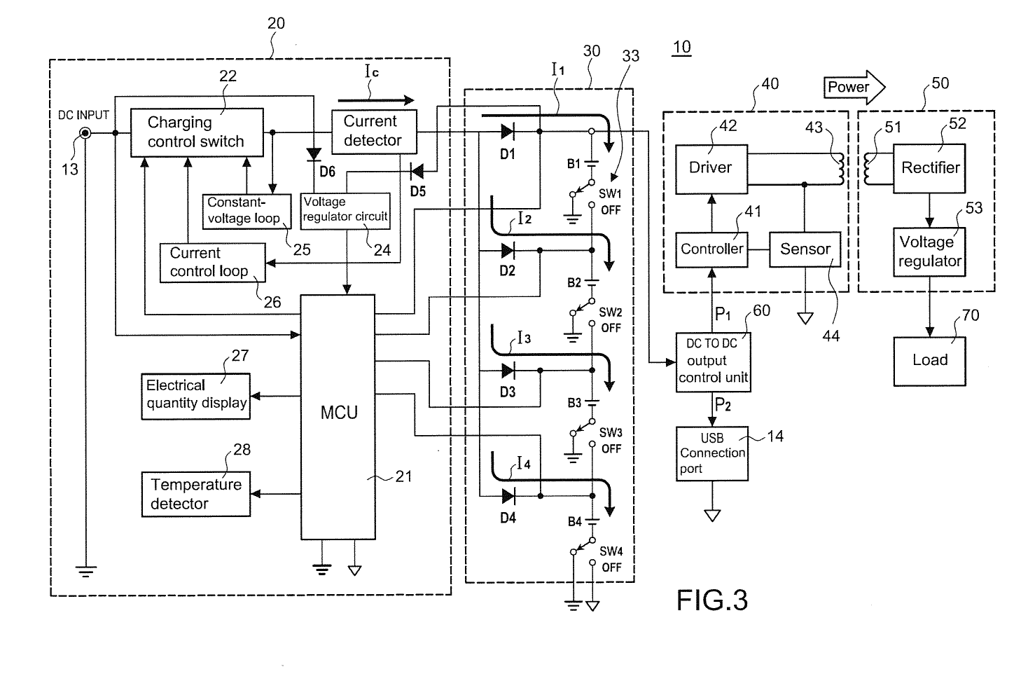

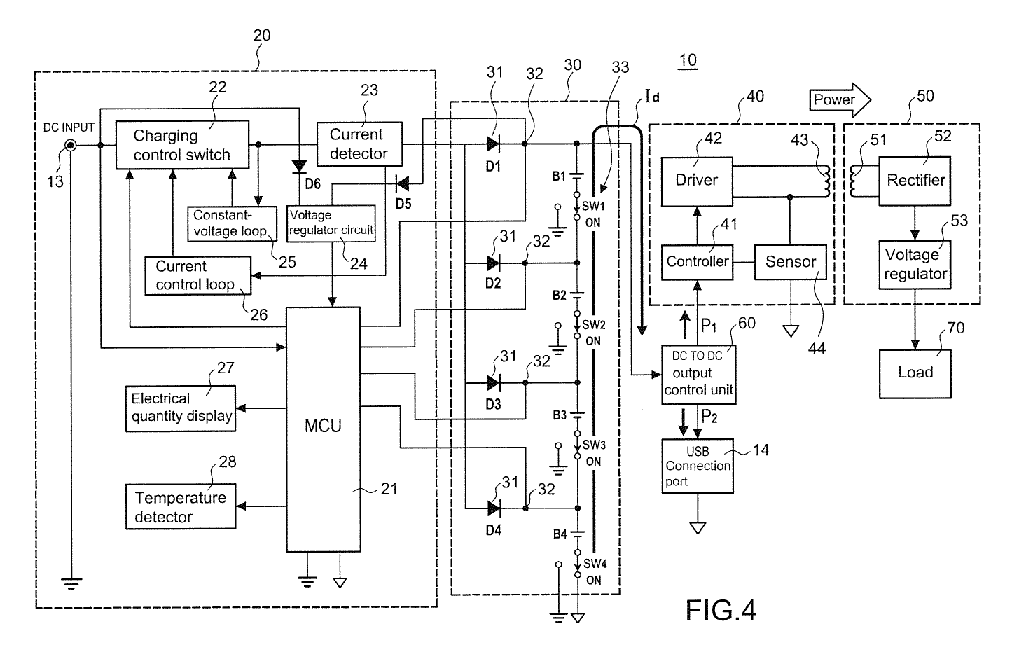

The present invention is characterized in that the power storing unit 30 arranged in the body 10 is composed of a multiple of nickel-hydrogen batteries B1˜B4 in series and each of the nickel-hydrogen batteries B1˜B4 has an anti-adverse-current element 31 at a positive terminal thereof. In this embodiment, the anti-adverse-current element 31 is composed of unidirectional diodes D1˜D4. A terminal voltage detection point 32 arranged between the anti-adverse-current element 31 and the positive terminals of the nickel-hydrogen batteries B1˜B4 are couple with the microprocessor 21 and each of the nickel-hydrogen batteries B1˜B4 has a switch 33 at a negative terminal thereof for each of the nickel-hydrogen batteries B1˜B4 forming a separate charging circuit. In this embodiment, the switch 33 is composed of a MOSFET and an electronic switch. With the reference to FIG. 3, when the power storing unit 30 is at a LOW voltage level, the switches SW1˜SW4 are turned OFF for the adjacent batteries being non-conductive so that the charging unit 20 outputs the charging circuit Ic to each of the nickel-hydrogen batteries B1˜B4 to form a plurality of charging loops I₁˜I₄ and a parallel-connected separated charging mode. With the reference to FIG. 4, when each of the nickel-hydrogen batteries B1˜B4 is fully charged and the microprocessor 21 detects a high voltage level, the switches SW1˜SW4 are turned ON and the parallel separate charge of the nickel-hydrogen batteries B1˜B4 are converted to a series-connected combined discharging mode.

A DC TO AC output control unit 60 is coupled with the power storing unit 30 and converts a discharging current I_{d} into an output power with a predetermined voltage level and at least a first output power P1 coupled with the wireless power transmitter 40. In the embodiment, the output power includes 19V power P1 and 5V power P2 but it is not a limitation. The output voltage and the number of the output power are changeable for different power specifications. In the embodiment, the wireless power transmitter 40 converts the 19V power P1 into a wireless charging signal and transmits the charging signal to the receptor 50 of the mobile device 70 to conduct charging and the DC TO AC output control unit 60 not only provides 19V power P1 for the wireless power transmitter 40 but the power required by the other power specifications. For example, the DC TO AC output control unit 60 provides 5V power P2 for an USB connection port 14 to charge the other electronic devices.

Whereby the power storing unit 30 switches the “parallel-connected separated charging mode” and “series-connected combined discharging mode” to conduct charging and discharging and combine with the DC TO AC output control unit 60 to provide stable high efficiency of the output power to the wireless power transmitter 40.

In the embodiment, the charging unit 20 includes a charging control switch 22 coupled with the DC output port 13, a current detector 23 having an end coupled with the charging control switch 22 and another end coupled with the power storing unit 30, a voltage regulator circuit 24 having an input end coupled between the DC output port 13 and the charging control switch 22, a constant-voltage loop 25 coupled with the charging control switch 22 and a current control loop 26 having an end coupled with the charging control switch 22 and another end coupled with the current detector 23 and the microprocessor 21 coupled with the charging control switch 22 and the voltage regulator circuit 24. Further, the microprocessor 21 is connected to an electrical quantity display 27 and a temperature detector 28 wherein the electrical quantity display 27 on the first surface 11 is composed of the LCD panel or LED components for issuing a warning signal when the battery power is low.

Further, the receptor 50 of the mobile device 70 is composed of a second coil 51, a rectifier 52 and a voltage regulator 53. The mobile device 70 here is a load. With the reference to FIG. 1, the mobile device 70 is arranged on the first surface 11 and the second surface 12 has 4 to 8 nickel-hydrogen batteries therein as the power storing unit 30. If there are 4 nickel-hydrogen batteries in the second surface 12, the size of the body 10 is like a normal smartphone; even if there are 8 nickel-hydrogen batteries in the second surface 12, the body 10 is not heavy at all. Besides, the DC TO AC output control unit 60 is coupled with the USB connection port 14 on the body 10 to provide 5V DC power for the electronic devices without the receptor 50.

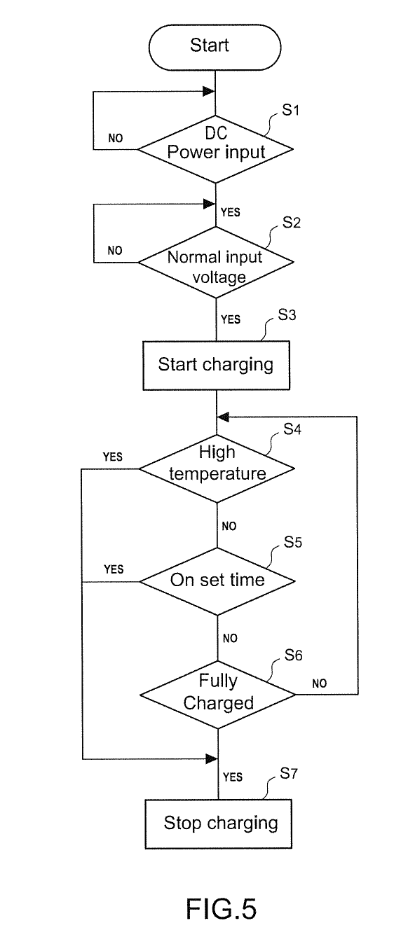

FIG. 5 is a flow diagram of the operating procedure of the charging unit 20. Step 1 S1 is to determine if there is a DC power input; step 2 S2 is to determine whether the input voltage is normal; step 3 S3 is to start charging the nickel-hydrogen batteries B1˜B4 in the parallel-connected separated charging mode as shown in FIG. 3. The negative terminals of each of the nickel-hydrogen batteries B1˜B4 are connected to the switch 33. That is, the switches SW1˜SW2 are grounding in the embodiment, forming separated charging loops I₁˜I₄.

In step 4 S4, if the temperature sensor 28 does not detect the high temperature, the process proceeds to step 5 S5 and if the microprocessor 21 does not come to set time, the nickel-hydrogen batteries B1˜B4 are continually charged until they are fully charged then it comes to step 6 S6. When the microprocessor 21 is determined that the nickel-hydrogen batteries B1˜B4 are fully charged by each of the terminal voltage detection points 28, it comes to step 7 S7 which stops charging.

In the aforesaid steps 1, 2, 4, 5 and 6 S1, S2, S4, S5 and S6, if the result of determining does not match the original settings, it does not continue next step but return to the preceding steps or stop charging. According to the charging control program, the present invention provides the stable charging process and high charging efficiency with security.

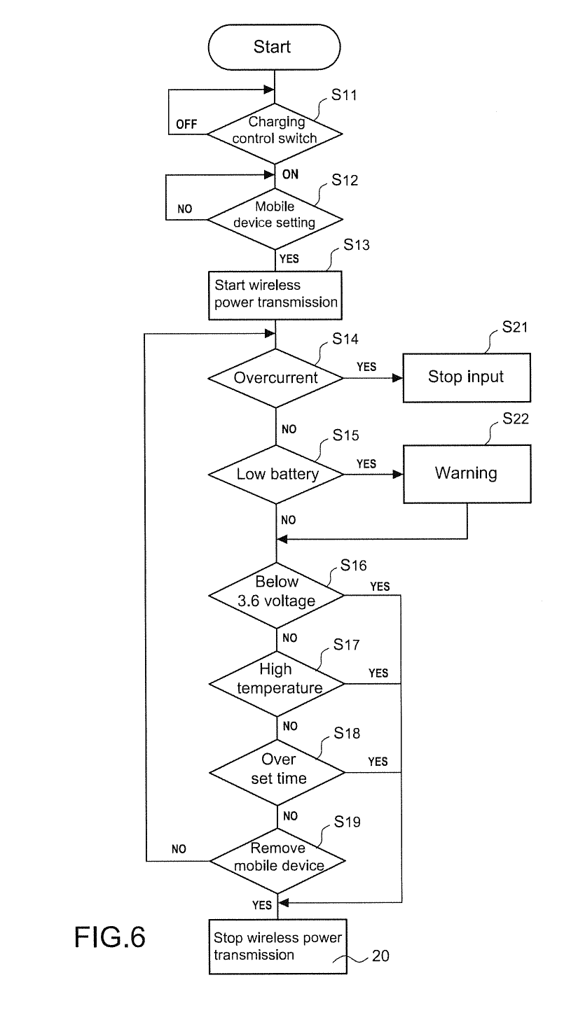

Further, FIG. 6 is a flow diagram of the operating procedure of the present invention used as a wireless charger. In step 11 S11, if the charging control switch 22 is ON, the process proceeds to step 12 S12 to determine if the mobile device 70 is set and if the mobile device 70 is set at the first surface 11 of the body 10, the process proceeds to step 13 S13 for the wireless power transmitter 40 transmitting the power. Step 14 S14 is to detect the current. In the embodiment, the current is set to be more than 3A. If there is overcurrent passing, the process proceeds to step 12 S12 and the current stops outputting. On the other hand, if there is set current passing, the process proceeds to step 15 S15 to detect the capacity of the batteries. If it is determined as low battery, the process proceeds to step 22 S22 for the electrical quantity display 27 issuing a low battery warning and then the process goes back to step 16 S16; however, if it does not determine the low battery, the process directly proceeds to step 16 S16 to detect the voltage and further proceeds to step 20 S20 when the batteries voltage is lower than the set value of 3.6V and the wireless power transmitter 40 stops transmitting. When the batteries voltage is more than the set value of 3.6V, the process proceeds to step 17 S17 to detect the temperature. In the embodiment, when the temperature is more than 60° C., the wireless power transmitter 40 stops transmitting; when the temperature is lower than 60° C., the process proceeds to step 18 S18 to detect the set time of 6 hours. If it is more than 6 hours, the wireless power transmitter 40 stops transmitting; if not, the process proceeds to step 19 S19 to determine if the mobile device 70 is removed. If the mobile device 70 is removed, the wireless power transmitter 40 stops transmitting; if not, the process goes back to step 14 S14 to continually transmit the power. The prevent invention provides the process to ensure the safety while using the charger.

Based on the features disclosed, the present invention provides the nickel-hydrogen batteries as the power storing unit of the charger and a control means of the parallel-connected separated charging mode and series-connected combined discharging mode to achieve the highest efficiency of power release. Moreover, such AA or AAA nickel-hydrogen batteries are the global harmonization of specifications, and therefore they can be removed from the present invention for other uses. In addition, the present invention has an intelligent control of electricity through the arrangement of the microprocessor and each of the detection circuits to achieve a stable wireless charger with high-efficiency and security.

What is claimed is:

1. A portable wireless charger, comprising:
a body having a first surface, a second surface and a DC input port;
a charging unit arranged in the body, having a microprocessor and related electronic components for outputting a charging current and an end thereof electronically connected to the DC input port;
an power storing unit provided for storing the charging current as electrical energy;
a wireless power transmitter coupled with the power storing unit and having a controller, a driver, a first coil and a sensor for converting the electrical energy into a AC signal and transmitting the AC signal to a receptor of an mobile device by the first coil;
wherein
the power storing unit arranged in the body is composed of a multiple of nickel-hydrogen batteries in series; each of the nickel-metal hydride batteries has an anti-adverse-current element at a positive terminal thereof and a terminal voltage detection point arranged between the anti-adverse-current element and the positive terminal of the nickel-hydrogen battery is couple with the microprocessor; each of the nickel-metal hydride batteries has a switch at a negative terminal thereof for each of the nickel-hydrogen batteries forming a separate charging circuit; when the power storing unit is at a LOW voltage level, the switches are turned off for the adjacent batteries being non-conductive so that the charging unit outputs the charging circuit to each of the nickel-hydrogen batteries to form a plurality of charging loop and a parallel-connected separated detection charging mode; when each of the nickel-hydrogen batteries is fully charged and the microprocessor detects a high voltage level, the switches are turned on and the parallel separate charge of the nickel-hydrogen batteries is converted to a series-connected combined discharging mode; and
a DC TO AC output control unit coupled with the power storing unit and converting a discharging current into an output power with a predetermined voltage level and at least a first output power coupled with the wireless power transmitter;
whereby the power storing unit switches the “parallel-connected separated charging mode” and “series-connected combined discharging mode” to conduct charging and discharging and combine with the DC TO AC output control to provide stable high efficiency of the output power to the wireless power transmitter.

2. The portable wireless charger as claimed in claim 1, wherein the charging unit includes a charging control switch coupled with the DC output port, a current detector having an end coupled with the charging control switch and another end coupled with the power storing unit, a voltage regulator circuit having an input end coupled between the DC output port and the charging control switch, a constant-voltage loop coupled with the charging control switch and a current control loop having an end coupled with the charging control switch and another end coupled with the current detector and the microprocessor coupled with the charging control switch and the voltage regulator circuit.

3. The portable wireless charger as claimed in claim 2, wherein the microprocessor is connected to an electrical quantity display and a temperature detector.

4. The portable wireless charger as claimed in claim 1, wherein the anti-adverse-current element is composed of unidirectional diodes.

5. The portable wireless charger as claimed in claim 1, wherein the switch is composed of a MOSFET and an electronic switch.

6. The portable wireless charger as claimed in claim 1, wherein the receptor of the mobile device is composed of a second coil, a rectifier and a voltage regulator.

7. The portable wireless charger as claimed in claim 1, wherein the DC TO AC output control unit includes a second output power coupled with a USB connection port on the body.
